(19) United States
(12) Patent Application Publication
(10) Pub. No.: US 2026/0156623 A1
(43) Pub. Date: Jun. 4, 2026

(54) METHODS, DEVICES AND MEDIUM FOR COMMUNICATION

(71) Applicant: NEC CORPORATION, Tokyo (JP)

(72) Inventors: Lin LIANG, Beijing (CN); Gang WANG, Beijing (CN)

(73) Assignee: NEC CORPORATION, Tokyo (JP)

(21) Appl. No.: 19/106,725

(22) PCT Filed: Sep. 30, 2022
(86) PCT No.: PCT/CN2022/123507

§ 371 Date: Feb. 26, 2025

(51) Int. Cl. H04W 72/0446; H04W 72/23

(52) U.S. Cl. CPC H04W 72/0446; H04W 72/23

(57) ABSTRACT

Example embodiments of the present disclosure relate to a solution for configuration of downlink control information. In this solution, a terminal device receives, from a network device, a first configuration for a first time domain resource allocation (TDRA) list of a plurality of first TDRA lists. The plurality of TDRA lists comprise a first TDRA list associated with a cell of a plurality of cells and indicating resource allocations for the cell. The terminal device also receives, from the network device, a second configuration for a second TDRA list. The second TDRA list indicates resource allocations for the plurality of cells. The terminal device receives, from the network device, an indication of a set of entries in the second TDRA list as well. The set of entries indicate resource allocations for a plurality of scheduled cells of the cells.

This application is a national stage of International Application No. PCT/CN2022/123507 filed on Sep. 30, 2022, which is hereby incorporated by reference in its entirety.

### FIELD

Example embodiments of the present disclosure generally relate to the field of communication techniques and in particular, to methods, devices, and medium for configuration of downlink control information.

### BACKGROUND

In Release (Rel)-15, which is the first version of New Radio (NR), one downlink control information (DCI) schedules one Physical Downlink Shared Channel (PDSCH) on one serving cell. In Rel-17, one DCI is enhanced to schedule multiple PDSCHs in different slots in time domain on one serving cell. In Rel-18, to further improve scheduling efficiency, DCI is allowed to schedule multiple PDSCH(s) on multiple component carriers (CCs). In the context of the present disclosure, component carriers may also be referred to as cells which may comprise serving cells. Such DCI is also called as multi-cell DCI (MC-DCI). However, how to control or reduce the payload is still needed to be considered.

### SUMMARY

In general, embodiments of the present disclosure provide methods, devices and computer storage medium for configuration of downlink control information.

In a first aspect, there is provided a communication method. The method comprises: receiving, from a network device, a first configuration for a first time domain resource allocation (TDRA) list of a plurality of first TDRA lists, a first TDRA list of the plurality of first TDRA lists associated with a cell of a plurality of cells and indicating resource allocations for the cell: receiving, from the network device, a second configuration for a second TDRA list, the second TDRA list indicating resource allocations for the plurality of cells; and receiving, from the network device, an indication of a set of entries in the second TDRA list, the set of entries indicating resource allocations for a plurality of scheduled cells of the cells.

In a second aspect, there is provided another communication method. The method comprises: transmitting, to a terminal device, a first configuration for a plurality of first TDRA lists, a first TDRA list of the plurality of first TDRA lists associated with a cell of a plurality of cells and indicating resource allocations for the cell: transmitting, to the terminal device, a second configuration for a second TDRA list, the second TDRA list indicating resource allocations for the plurality of cells; and transmitting, to the terminal device, an indication of a set of entries in the second TDRA list, the set of entries indicating resource allocations for a plurality of scheduled cells of the cells.

In a third aspect, there is provided yet another communication method. The method comprises: receiving, at a terminal device from a network device, downlink control information (DCI) for scheduling associated with a plurality of cells; and validating the scheduling based on at least one or more new data indicators (NDIs) associated with the plurality of cells in the DCI.

In a fourth aspect, there is provided a further communication method. The method comprises: receiving, at a terminal device from a network device, downlink control information (DCI) for scheduling associated with a plurality of cells; and validating the scheduling based on at least one or more new data indicators (NDIs) associated with the plurality of cells in the DCI.

In a fifth aspect, there is provided still a further communication method. The method comprises: scrambling, at a network device, downlink control information (DCI) for scheduling associated with a plurality of cells, with a cell radio network temporary identifier (C-RNTI) and/or a modulation and coding scheme cell radio network temporary identifier (MCS-C-RNTI), to schedule more than one cell of the plurality of cells; and transmitting the scrambled DCI to a terminal device.

In a sixth aspect, there is provided a terminal device. The terminal device comprises at least one processor; and at least one memory coupled to the at least one processor and storing instructions thereon, the instructions, when executed by the at least one processor, causing the terminal device to perform the method according to the first aspect or the third aspect.

In a seventh aspect, there is provided a network device. The network device comprises at least one processor; and at least one memory coupled to the at least one processor and storing instructions thereon, the instructions, when executed by the at least one processor, causing the network device to perform the method according to the second, fourth, or fifth aspect.

In an eighth aspect, there is provided a computer readable medium having instructions stored thereon, the instructions, when executed on at least one processor, causing the at least one processor to carry out the method according to any of the first, second, third, fourth or fifth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates a signaling flow of TDRA configuration for MC-DCI in accordance with some embodiments of the present disclosure:

FIG. 3 illustrates a flowchart of a communication method implemented at a terminal device in accordance with some embodiments of the present disclosure:

FIG. 4 illustrates a schematic diagram of an example TDRA table in accordance with some embodiments of the present disclosure:

FIG. 5 illustrates a schematic diagram of another example TDRA table in accordance with some embodiments of the present disclosure:

FIG. 6 illustrates a flowchart of a communication method implemented at a network device in accordance with some embodiments of the present disclosure:

FIG. 7 illustrates a signaling flow of scheduling validation for MC-DCI in accordance with some embodiments of the present disclosure:

FIG. 8 illustrates a flowchart of a further communication method implemented at a terminal device in accordance with some embodiments of the present disclosure:

FIG. 9 illustrates a flowchart of a further communication method implemented at a network device in accordance with some embodiments of the present disclosure:

FIG. 10 illustrates a signaling flow of DCI scrambling in accordance with some embodiments of the present disclosure:

FIG. 11 illustrates a flowchart of a still further communication method implemented at a network device in accordance with some embodiments of the present disclosure; and

FIG. 12 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability: It generally includes a model which has been trained from numerous collected data for a specific function, and can be used to predict some information.

The terminal or the network device may work on several frequency ranges, e.g., FR1 (e.g., 450 MHz to 6000 MHz), FR2 (e.g., 24.25 GHz to 52.6 GHZ), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘include, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest.’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in spatial domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

Embodiments of the present disclosure provide a solution for measurement reporting for phase-based positioning.

Principles and implementations of the present disclosure will be described in detail below with reference to the figures.

### Example of Communication Environment

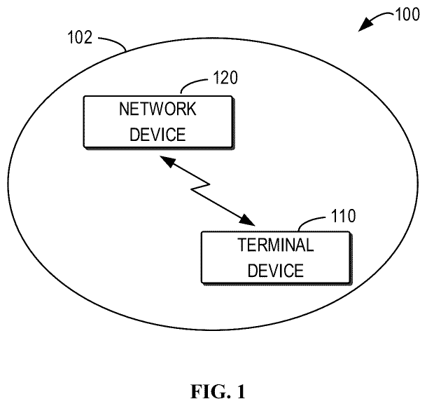

FIG. 1 illustrates a schematic diagram of an example communication environment 100 in which example embodiments of the present disclosure can be implemented. In the communication environment 100, a plurality of communication devices, including a terminal device 110 and a network device 120, can communicate with each other.

In the example of FIG. 1, the terminal device 110 may be a UE and the network device 120 may be a base station serving the UE. The serving area of the network device 120 may be called a cell 102.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell 102, and one or more additional cells may be deployed in the communication environment 100. It is noted that although illustrated as a network device, the network device 120 may be another device than a network device. Although illustrated as a terminal device, the terminal device 110 may be other devices than a terminal device.

In the following, for the purpose of illustration, some example embodiments are described with the terminal device 110 operating as a UE and the network device 120 operating as a base station. However, in some example embodiments, operations described in connection with a terminal device may be implemented at a network device or other device, and operations described in connection with a network device may be implemented at a terminal device or other device.

In some example embodiments, if the terminal device 110 is a terminal device and the network device 120 is a network device, a link from the network device 120 to the terminal device 110 is referred to as a downlink (DL), while a link from the terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

### Work Principle and Example Process

Currently, a PUSCH/PDSCH TDRA list is configured per Bandwidth part (BWP) per serving cell by radio resource control (RRC) signalling. Dynamic scheduling and configured grant use the same list. Single PXSCH (e.g. PUSCH/PDSCH) and multiple PXSCH scheduling use the same list. A DCI format may indicate a MC-DCI scheduling for DL and UL separately: To reduce DCI payload, bit fields in DCI may be divided into several types. For type-1 and configured type-3 field, one common field may be indicated in DCI for multiple cells. Time Domain Resource Allocation (TDRA) is one of type-1 or type-3 bit fields. Configuration regarding TDRA from a physical layer or RRC layer signaling may be further considered.

Example embodiments of the present disclosure provide a solution for DCI configuration. In this solution, a terminal device receives, from a network device, a first configuration for a first TDRA list of a plurality of first TDRA lists and a second configuration for a second TDRA list are received, for example, in a single message or separate messages. In the context of the present disclosure, a TDRA list may also be referred to as a TDRA table. The first TDRA list which is associated with a cell of a plurality of cells and indicates resource allocations for the cell. The second TDRA list indicates resource allocations for the plurality of cells. The terminal device further receives, from the network device, an indication of a set of entries in the second TDRA list. The set of entries indicate resource allocations for a plurality of scheduled cells of the cells.

Through this solution, with the configuration for the second TDRA list, the terminal device can be aware of resource allocation for the scheduled cells based on the received indication of entries in the second TDRA list. In this way, in multi-cell scheduling. TDRA configurations for multiple cells may be indicated to a UE in a flexible and efficiently way:

Principles and implementations of the present disclosure will be described in detail below with reference to the figures.

Reference is made to FIG. 2, which illustrates a signaling flow 200 of TDRA configuration for MC-DCI in accordance with some embodiments of the present disclosure. For the purposes of discussion, the signaling flow 200 will be discussed with reference to FIG. 1, for example, by using the terminal device 110 and the network device 120.

In the example embodiments of FIG. 2, the network device 120 transmits (205) a first configuration for a first TDRA list of a plurality of first TDRA lists to the terminal device 110. The first TDRA list may be associated with a cell of a plurality of cells and indicate resource allocations for the cell. For example, the first TDRA list may be a TDRA list for a single cell. The terminal device 110 receives (210) the first configuration from the network device 120. With the first configuration, the terminal device 110 may be aware of information about resource allocations for the single cell associated with that first TDRA list.

Before or after or in parallel to the transmission (205) of the first configuration, the network device 120 transmits (215) a second configuration for a second TDRA list to the terminal device 110. The second TDRA list indicates resource allocations for the plurality of cells, and may be, for example, a multi-cell TDRA association table, a TDRA table for MC-DCI, or the like. The multi-cell TDRA association table may indirectly indicate the resource allocations for the plurality of cells. The terminal device 110, upon receiving (220) the second configuration from the network device 120, may obtain the second TDRA list.

It is to be understood that the first configuration and the second configuration may be transmitted in the same message or in separated messages. The message(s) may be, for instance, a RRC message, or other suitable message(s). It is also to be understood that there is no limitation on the transmission forms or timings of the first and second configurations.

According to embodiments of the present application, the network device 120 further transmits (225), to the terminal device 110, an indication of a set of entries in the second TDRA list. The set of entries indicate resource allocations for a plurality of scheduled cells of the cells. For example, the set of entries may be a row of the second TDRA list or table. The set of entries may directly or indirectly indicate the resource allocation for the plurality of scheduled cells.

Upon receiving (230) the indication, the terminal device 110 may know the resource allocation of the scheduled cells. In this way, flexibility on multi-cell scheduling can be obtained.

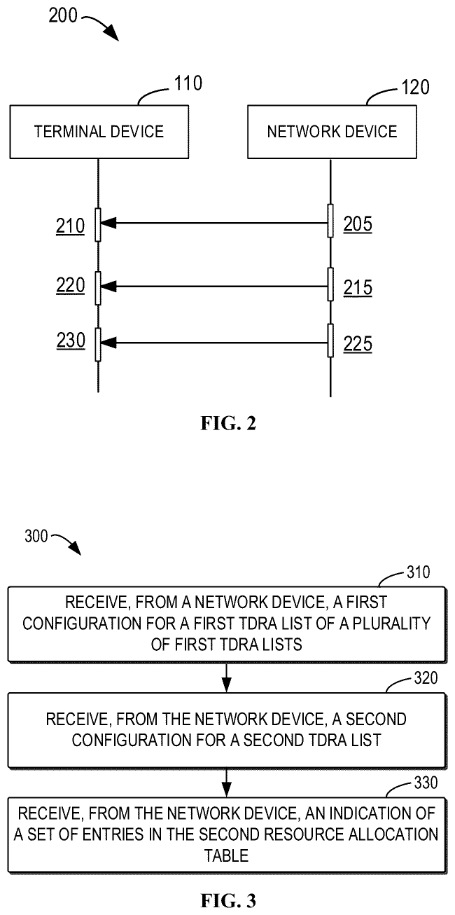

FIG. 3 illustrates a flowchart of a communication method 300 implemented at a terminal device in accordance with some embodiments of the present disclosure. For the purpose of discussion, the method 300 will be discussed with reference to FIG. 1, for example, by using the terminal device 110 and the network device 120. The method 300 will be described from the perspective of the terminal device 110 in FIG. 1.

At block 310, the terminal device 110 receives a first configuration for a first TDRA list of a plurality of first TDRA lists from the network device 120. A first TDRA list of the plurality of first TDRA lists is associated with a cell of a plurality of cells and indicates resource allocations for the cell.

In some embodiments, the first configuration may be received in a higher layer signaling, for example, a radio resource control (RRC) signaling, or other suitable message.

At block 320, the terminal device 110 receives, from the network device 120, a second configuration for a second TDRA list. The second TDRA list indicates resource allocations for the plurality of cells. In some embodiments, the second configuration may be received via RRC signaling, which may be the same or different RRC signaling as that comprising the first configuration.

At block 330, the terminal device 110 receives, from the network device 120, an indication of a set of entries in the second TDRA list. The set of entries indicate resource allocations for a plurality of scheduled cells of the cells. In some embodiments, the terminal device 110 may receive the indication of the set of entries in DCI.

In some embodiments, the second TDRA list may comprise a multi-cell TDRA association table. In this case, an entry in the set of entries may comprise various information. For example, an entry in the set of entries may comprise an entry index indicating an entry in one of the first TDRA lists associated with a scheduled cell of the plurality of scheduled cells. The entry in the first TDRA list may comprise resource allocation information for the scheduled cell.

Additionally, in some embodiments, the entry in the set of entries may further comprise an index of the scheduled cell, an index of a scheduled bandwidth part of the scheduled cell, and/or the like.

Alternatively, the second TDRA list may comprise a TDRA table for MC-DCI. In this case, an entry in the set of entries may comprise an index of resource allocation information for a scheduled cell of the plurality of scheduled cells. In this case, the indication of the set of entries indicates an index of the resource allocation information for the plurality of scheduled cells.

Additionally, in some embodiments, no matter what table the second TDRA list may comprise, an entry in the set of entries may indicate that a cell of the plurality of cells is non-scheduled.

As to entries in the second resource allocation, in some embodiments, they may be divided into a plurality of groups of entries. One of the plurality of groups may be associated with a cell of the plurality of cells. In some embodiments, two entries in the group may comprise the same entry index. Alternatively, or in addition, the numbers of entries in two of the plurality of groups may be the same.

Embodiments of the present application may be implemented in a variety of ways. In some implementations, a first TDRA list with a single Start and length indicator value (SLIV) in each entry may be configured per BWP per serving cell by RRC. In this case, the terminal device 110 may receive the first TDRA list as the first configuration from the network device 120. The second configuration may comprise a second multi-cell TDRA association table configured by RRC and may be signaled from the network device 120 to the terminal device 110, for multiple cells scheduled by a single DCI. Each entry in the TDRA association table may comprise a list of entry index of the TDRA table in the corresponding cell.

In one embodiment, the DCI may indicate the entry index of PDSCH-TDRA-MC-Association-list-r18 (e.g. the second TDRA list). Each entry may include TDRA configurations of multiple cells. PDSCH-TDRA-SC-r18 may configure TDRA information for a cell. The entry-index may indicate a row of the first TDRA table configured for the cell. Additionally, a serving-cell index and/or BWP-index may be optionally indicated in PDSCH-TDRA-SC-r18.

Table 1 shows some example implementations for the PDSCH-TDRA-MC-Association-list-r18, PDSCH-TDRA-MC-Association-r18 and PDSCH-TDRA-SC-r18. It is to be understood that these examples are just illustrated for purpose of discussion, rather than limitation.

```
TABLE 1
  PDSCH-TDRA-MC-Association-list-r18 ::= SEQUENCE
(SIZE(1..maxNrofMC-DL-Allocations)) OF PDSCH-TDRA-MC-Association-r18
PDSCH-TDRA-MC-Association-r18 ::= SEQUENCE (SIZE(1..maxNrofMC-OneDCI))
OF PDSCH-TDRA-SC-r18
PDSCH-TDRA-SC-r18 ::= SEQUENCE
{
    entry-index INTEGER(0..7),
    serving-cell-index OPTIONAL,
    BWP-index OPTIONAL
}
```

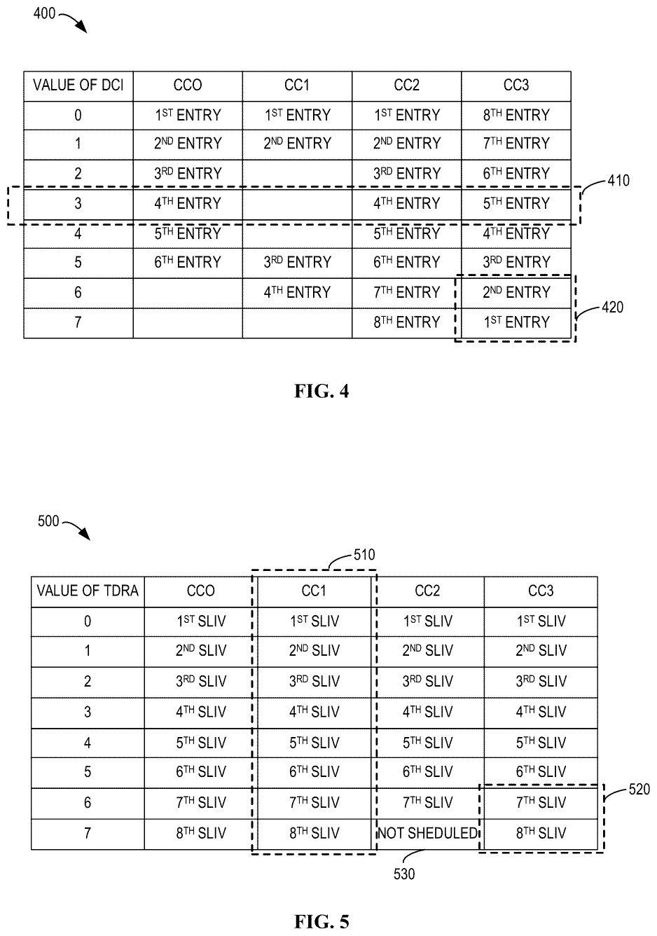

FIG. 4 illustrates a schematic diagram of an example multi-cell TDRA association table 400 in accordance with some embodiments of the present disclosure. As shown in FIG. 4, a row 410 of the multi-cell TDRA association table 400 comprises a plurality of entries 420. Each of the entries 420 comprises an entry index that indicates an entry of a plurality of first TDRA lists for a plurality of component carriers (or cells). The multi-cell TDRA association table 400 may be indicated by the parameter PDSCH-TDRA-MC-Association-list-r18, a row 410 may be indicated by the parameter PDSCH-TDRA-MC-Association-r18, and entries 420 may be indicated by the parameter PDSCH-TDRA-SC-r18.

The above embodiments of the present disclosure can achieve quite a few benefits compared with conventional solutions. First, it can give flexibility on multi-cell scheduling. Without the association table, if the numbers of 0 configured for Cell 1, 2 and 3 are decreased progressively, then only Cell 1+ Cell 2+ Cell 3, or Cell 2+ Cell 3 can be indicated by MC-DCI. Cell 1+ Cell 3 will not be scheduled by such implicit association. On the other hand, explicit association can configure Cell 1+ Cell 2+ Cell 3 by indicating serving cell index and TDRA combination of the cells.

Additionally, BWP index can also be included. If included, it could firstly preclude entries that includes non-scheduled serving cell(s) and non-scheduled BWP(s) in PDSCH-TDRA-MC-Association-r18, and DCI indicates the entry index of the remaining list.

In some alternative implementations, a second TDRA table for MC-DCI in addition to a first TDRA table for single cell scheduling may be configured per BWP per serving cell. In this case, the terminal device 110 may receive the second TDRA table as the second configuration from the network device 120. The number of entries in the second table across cells for MC-DCI may be the same. If the MC-DCI indicates an index of the TDRA table, the index may apply the second table in each cell. An indication in RRC to indicate TDRA may be not scheduled, hence the cell is not scheduled.

Table 2 illustrates some example implementations for the PDSCH-TDRA-MC-list-r18, PDSCH-TimeDomainResourceAllocationList-r16 and PDSCH-TimeDomainResourceAllocation-r16. It is to be understood that these examples are just illustrated for purpose of discussion, rather than limitation.

TABLE 2
PDSCH-TDRA-MC-List-r18 ::= SEQUENCE (SIZE(1..maxNrofDL-Allocations)) OF
PDSCH-TimeDomainResourceAllocation-r16

| | | |
|---|---|---|
| PDSCH-TimeDomainResourceAllocationList-r16 | ::= | SEQUENCE |

| | |
|---|---|
| (SIZE(1..maxNrofDL-Allocations)) | OF |

PDSCH-TimeDomainResourceAllocation-r16
PDSCH-TimeDomainResourceAllocation-r16 ::= SEQUENCE {

| | |
|---|---|
| k0-r16 | INTEGER(0..32) OPTIONAL, -- Need S |
| mappingType-r16 | ENUMERATED {typeA, typeB}, |
| startSymbolAndLength-r16 | INTEGER (0..127), |
| repetitionNumber-r16 | ENUMERATED {n2, n3, n4, n5, n6, |
| n7, n8, n16} | OPTIONAL, -- Cond Formats1-0and1-1 |

```
      ...,
    [[
```

| | | |
|---|---|---|
| not-scheduled | ENUMERATED | {true} |

OPTIONAL -- Need S
]]
}

FIG. 5 illustrates a schematic diagram of an example TDRA table 500 for MC-DCI in accordance with some embodiments of the present disclosure. As shown in FIG. 5, a column 510 of the TDRA table 500 comprises a plurality of entries 520. Each of the entries 520 comprises an SLIV index of a component carrier (or cells). In TDRA table 500, an entry 530 indicates that CC1 is not scheduled. The TDRA table 500 may be indicated by the parameter PDSCH-TDRA-MC-list-r18, a column 510 may be indicated by the parameter PDSCH-TimeDomainResourceAllocationList-r16, and entries 520 may be indicated by the parameter PDSCH-TimeDomainResourceAllocation-r16.

The above embodiments of the present disclosure can also achieve benefits. Specifically, in some scenarios, a single TDRA for each cell may not be suitable for MC-DCI scheduling. For example, due to duplex and Tx-Rx switching time restriction, some TDRA combination is not suitable. Two TDRA tables applying for single cell and multi-cell scheduling can adapt to each scenario better.

Moreover, conventional association table across cell is complex when BWP switching is considered in MC-DCI, since different BWPs have different TDRA configurations which may need different association table. In contrast, the TDRA table according to embodiments of the present disclosure can be conveniently and easily applied.

Furthermore, according to embodiments of the present disclosure, non-scheduled indication can allow the TDRA table to indicate the cell is not scheduled by MC-DCI. In this way, flexibility can be achieved.

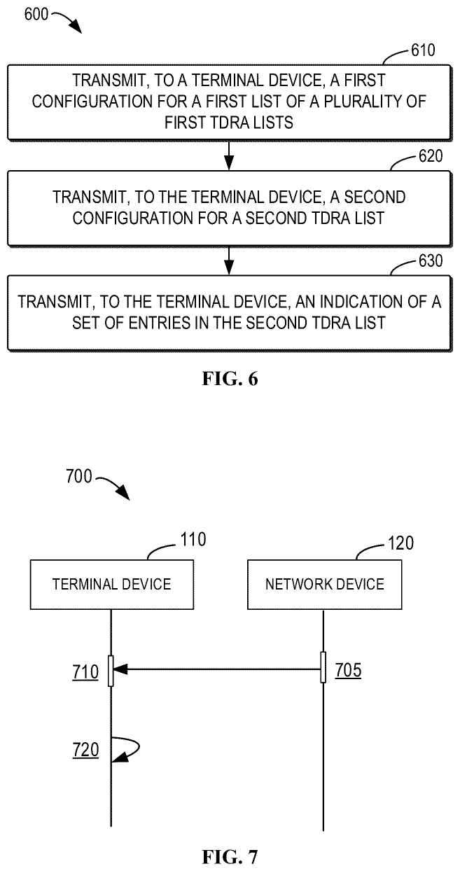

FIG. 6 illustrates a flowchart of a communication method 600 implemented at a network device in accordance with some embodiments of the present disclosure. For the purpose of discussion, the method 600 will be discussed with reference to FIG. 1, for example, by using the terminal device 110 and the network device 120. The method 600 will be described from the perspective of the network device 120 in FIG. 1.

At block 610, the network device 120 transmits a first configuration for a first TDRA list of a plurality of first TDRA lists to the terminal device 110. A first TDRA list of the plurality of first TDRA lists is associated with a cell of a plurality of cells and indicates resource allocations for the cell.

In some embodiments, the first configuration may be transmitted in a higher layer signaling, for example, a radio resource control (RRC) signaling, or other suitable message.

At block 320, the network device 120 transmits a second configuration for a second TDRA list to the terminal device 110. The second TDRA list indicates resource allocations for the plurality of cells. In some embodiments, the second configuration may be received via RRC signaling, which may be the same or different RRC signaling as that comprising the first configuration.

At block 330, the network device 120 transmits an indication of a set of entries in the second TDRA list to the terminal device 110. The set of entries indicate resource allocations for a plurality of scheduled cells of the cells. In some embodiments, the network device 120 may transmit the indication of the set of entries in DCI.

In some embodiments, the second TDRA list may comprise a multi-cell TDRA association table. In this case, an entry in the set of entries may comprise various information. For example, an entry in the set of entries may comprise an entry index for in one of the first TDRA lists associated with a scheduled cell of the plurality of scheduled cells. This entry index may indicate an entry in a first TDRA list, which may comprise resource allocation information for the scheduled cell.

In addition to the above, the entry in the set of entries may further comprise an index of the scheduled cell, an index of a scheduled bandwidth part of the scheduled cell, and/or the like.

Alternatively, the second TDRA list may comprise a TDRA table for MC-DCI. In this case, an entry in the set of entries may comprise an index of resource allocation information for a scheduled cell of the plurality of scheduled cells. In this case, the indication of the set of entries indicates an index of the resource allocation information for the plurality of scheduled cells.

Additionally, in some embodiments, no matter what table the second TDRA list may comprise, an entry in the set of entries may indicate that a cell of the plurality of cells is non-scheduled.

As to entries in the second resource allocation, in some embodiments, they may be divided into a plurality of groups of entries. One of the plurality of groups may be associated with a cell of the plurality of cells. In some embodiments, two entries in the group may comprise the same entry index. Alternatively, or in addition, one of the plurality of groups may have the same number of entries as another group of the plurality of groups.

During scheduling, a terminal device may validate, for scheduling activation or scheduling release, a DL Semi-Persistent Scheduling (SPS) assignment Physical Downlink Control Channel (PDCCH) or a configured UL grant Type 2 PDCCH in some cases. For example, these cases may comprise one or more of the following situations: the Cyclic Redundancy Check (CRC) of a corresponding DCI format is scrambled with a Configured scheduling Radio Network Temporary Identifier (CS-RNTI) provided by cs-RNTI or a Group configured scheduling RNTI (G-CS-RNTI) provided by g-cs-RNTI: the new data indicator field in the DCI format for the enabled transport block is set to ‘0’: the DFI flag field, if present, in the DCI format is set to ‘0’: the time domain resource assignment field in the DCI format indicates a row with single SLIV: or if validation is for scheduling activation and if the PDSCH-to-HARQ_feedback timing indicator field in the DCI format is present, the PDSCH-to-HARQ_feedback timing indicator field does not provide an inapplicable value from dl-DataToUL-ACK-r16.

If a terminal device is provided with more than one configuration for UL grant Type 2 PUSCH or for SPS PDSCH, a value of the Hybrid Automatic Repeat Request (HARQ) process number field in a DCI format indicates an activation for a corresponding UL grant Type 2 Physical Uplink Shared Channel (PUSCH) or for a SPS Physical Downlink Shared Channel (PDSCH) configuration with a same value as provided by ConfiguredGrantConfigIndex or by sps-ConfigIndex, respectively.

Table 3 shows special fields for DL SPS and UL grant Type 2 scheduling activation PDCCH validation. Table 4 shows special fields for DL SPS and UL grant Type 2 scheduling release PDCCH validation.

TABLE 3

| | DCI format 0_0/0_1 | DCI format 1_0 | DCI format 1_1 |
|---|---|---|---|
| HARQ process number | set to all ‘0’s | set to all ‘0’s | set to all ‘0’s |
| Redundancy version | set to ‘00’ | set to ‘00’ | For the enabled transport |
| | | | block: set to ‘00’ |

TABLE 4

| | DCI format 0_0 | DCI format 1_0 |
|---|---|---|
| HARQ process number | set to all ‘0’s | set to all ‘0’s |
| Redundancy version | set to ‘00’ | set to ‘00’ |
| Modulation and coding scheme | set to all ‘1’s | set to all ‘1’s |
| Frequency domain resource | set to all ‘1’s | set to all ‘1’s |
| assignment | | |

In view of the above, there is need to solve the problem of how to indicate and validate MC-DCI to indicate or release SPS/CG grant relate to multiple cells.

In this regard, embodiments of the present application provide a solution of SPS/CG validation for MC-DCI. In this solution, a network device transmits downlink control information for scheduling associated with a plurality of cells. A terminal device receives the downlink control information and validates the scheduling at least based on one or more new data indicators associated with the plurality of cells in the downlink control information. In this way, the SPS/CG validation for MC-DCI can be performed efficiently.

FIG. 7 illustrates a signaling flow 700 of scheduling validation for MC-DCI in accordance with some embodiments of the present disclosure. For the purposes of discussion, the signaling flow 700 will be discussed with reference to FIG. 1, for example, by using the terminal device 110 and the network device 120.

In the example embodiments of FIG. 7, the network device 120 transmits (705) DCI for scheduling associated with a plurality of cells to a terminal device 110. One or more new data indicators (NDIs) associated with the plurality of cells in the DCI is set to predetermined values to enable the terminal device to validate the scheduling. Upon receipt (710) of the DCI, the terminal device 110 validates (720) the scheduling at least based on the one or more NDIs in the DCI.

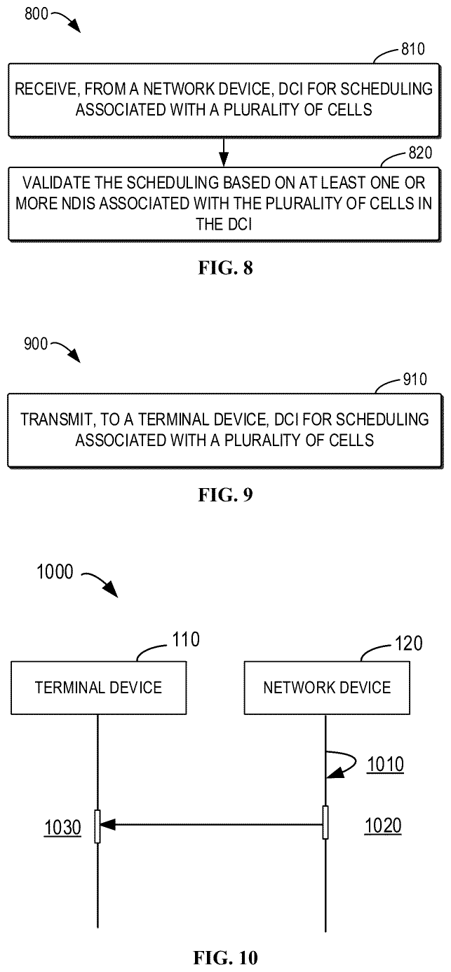

Related implementations of the present disclosure will be described in detail below with reference to FIG. 8 and FIG. 9. FIG. 8 illustrates a flowchart of a further communication method 800 implemented at a terminal device in accordance with some embodiments of the present disclosure. For the purpose of discussion, the method 800 will be discussed with reference to FIG. 1, for example, by using the terminal device 110 and the network device 120. The method 800 will be described from the perspective of the terminal device 110 in FIG. 1.

At block 810, the terminal device 110 receives, from the network device 120, DCI for scheduling associated with a plurality of cells. In some embodiments, the DCI may comprise a plurality of NDIs. One of the plurality of NDIs may be associated with a cell of the plurality of cells.

At block 820, the terminal device 110 validates the scheduling based on at least one or more new data indicators (NDIs) associated with the plurality of cells in the DCI.

In some embodiments, the one or more NDIs may comprise the plurality of NDIs. In this case, at block 820, the terminal device 110 may determine whether the plurality of NDIs are all zero. If yes, the terminal device 110 may determine that the scheduling is valid.

Alternatively, in some embodiments, the one or more NDIs comprise one or more NDIs of the plurality of NDIs set to zeros and associated with one or more cells of the plurality of cells. In such case, if the one or more NDIs are set to be zeros, the terminal device 110 may determine that scheduling of the one or more cells is to be validated. Then, the terminal device 110 may validate the scheduling of the one or more cells.

Alternatively, the terminal device 110 may determine whether the DCI is scrambled with a configured scheduling radio network temporary identifier (CS-RNTI). If yes, the terminal device 110 may determine that the scheduling is to be validated. Then, the terminal device 110 may validate the scheduling based on at least the one or more NDIs.

Additionally, in some cases, the terminal device 110 may determine scheduling is not to be validated. For example, if a field of an NDI of the plurality of NDIs is set to all ones and associated with a cell of the plurality of cells, the terminal device 110 may determine that the scheduling of the cell is not to be validated.

In some embodiments, the scheduling may comprise activation or deactivation of a configured grant or semi-persistent scheduling (SPS) assignment associated with the plurality of cells. That is, at block 820, the terminal device 110 may validate the activation or the deactivation of a configured grant or SPS assignment.

Field(s) in the DCI may be useful for validation at block 820. In some embodiments, at block 820, the terminal device 110 may validate the scheduling based on one or more further fields in the DCI. The one or more further fields may be related to several factors, for example, but not limited to, one or more hybrid automatic repeat request (HARQ) process numbers, redundancy versions, modulation and coding schemes, and/or frequency domain resource assignment, associated with the plurality of cells.

The above embodiments of the present disclosure can be implemented in a variety of ways. In some implementations, MC-DCI format 1_X/0)_X may be scrambled with a CS-RNTI to activate or release SPS assignment or configured UL grant for multiple cells. In some implementations, the terminal device 110 may validate, for scheduling activation or scheduling release, a DL SPS assignment PDCCH or a configured UL grant Type 2 PDCCH. In some implementations, if NDI fields for all cells indicate ‘0’, the terminal device 110 may determine that the DCI is valid. In some implementations, fields for activating or release SPS assignment or a configured grant for a single cell may be validated.

Corresponding advantages can be achieved based on the above embodiments and/or implementations. For example, it allows MC-DCI scrambled with a CS-RNTI. It can also activate or release SPS assignment or configured UL grant for multiple cells by a single DCI to reduce PDCCH overhead. Moreover, it can limit MC-DCI scrambled with a CS-RNTI only for activating or release, i.e. preclude retransmission scheduling, which can reduce processing complexity that does not need to treat different cases together.

According to further embodiments of the present disclosure, in some implementations, MC-DCI format 1_X/0)_X may be not scrambled with a CS-RNTI, i.e. only scrambled with C-RNTI/MCS-C-RNTI. As an alternative, MC-DCI format 1_X/0)_X may be scrambled with a CS-RNTI with only single cell scheduling, i.e. does not expect scrambled with a CS-RNTI to schedule multiple cells PXSCH.

In this way, MC-DCI may not be suitable for CG/SPS scheduling. PDSCH/PUSCH reception on different cell may have different ACK/NACK results and need different retransmission. Some cells may not need retransmission that MC-DCI is hard to handle. Meanwhile, MC-DCI not scrambled by CS-RNTI can reduce PDCCH blind detection by not try a comparing of RNTI value.

FIG. 9 illustrates a flowchart of a further communication method 900 implemented at a network device in accordance with some embodiments of the present disclosure. For the purpose of discussion, the method 900 will be discussed with reference to FIG. 1, for example, by using the terminal device 110 and the network device 120. The method 900 will be described from the perspective of the network device 120 in FIG. 1.

At block 910, the network device 120 transmits DCI for scheduling associated with a plurality of cells to a terminal device 110. One or more new data indicators (NDIs) associated with the plurality of cells in the DCI is set to predetermined values to enable the terminal device to validate the scheduling.

In some embodiments, the DCI may comprise a plurality of NDIs. One of the plurality of NDIs may be associated with a cell of the plurality of cells.

In some embodiments, the one or more NDIs may comprise the plurality of NDIs and the predetermined values are zeros. Upon receipt of the DCI, the terminal device 110 may determine that the scheduling is valid when it finds the plurality of NDIs are all zero.

In some embodiments, the one or more NDIs may be associated with one or more cells of the plurality of cells to indicate that scheduling of the one or more cells is to be validated. In this case, based on the DCI, the terminal device 110 may understand that the validation of the scheduling of the one or more cells is to be performed.

In some embodiments, a field of an NDI of the plurality of NDIs may be set to all ones to indicate that scheduling of a cell of the plurality of cells associated with the NDI comprises retransmission of a configured grant (CG) or semi-persistent scheduling (SPS) assignment for the cell.

In some embodiments, when transmitting the DCI, the network device 120 may first scramble the DCI with a configured scheduling radio network temporary identifier (CS-RNTI) to indicate that the scheduling is to be validated. Then the network device 120 may transmit the scrambled DCI to the terminal device 110.

In some embodiments, the scheduling may comprise activation or deactivation of a configured grant or semi-persistent scheduling (SPS) assignment associated with the plurality of cells.

In some embodiments, one or more further fields in the DCI may be set to predetermined values to enable the terminal device to further validate the scheduling. The one or more further fields may be related to several factors, for example, but not limited to, one or more hybrid automatic repeat request (HARQ) process numbers, redundancy versions (RVs), modulation and coding schemes (MCSs), and/or frequency domain resource assignment (FDRA), associated with the plurality of cells.

FIG. 10 illustrates a signaling flow 1000 of DCI scrambling in accordance with some embodiments of the present disclosure. For the purposes of discussion, the signaling flow 1000 will be discussed with reference to FIG. 1, for example, by using the terminal device 110 and the network device 120.

In the example embodiments of FIG. 10, the network device 120 scrambles (1010) downlink control information (DCI) for scheduling associated with a plurality of cells, with a cell radio network temporary identifier (C-RNTI) and/or a modulation and coding scheme cell radio network temporary identifier (MCS-C-RNTI), to schedule more than one cell of the plurality of cells. Then, the network device 120 transmits (1020) the scrambled DCI to the terminal device 110. Upon receiving (1030) the scrambled DCI, the terminal device 110 may perform blind decoding of the scrambled DCI.

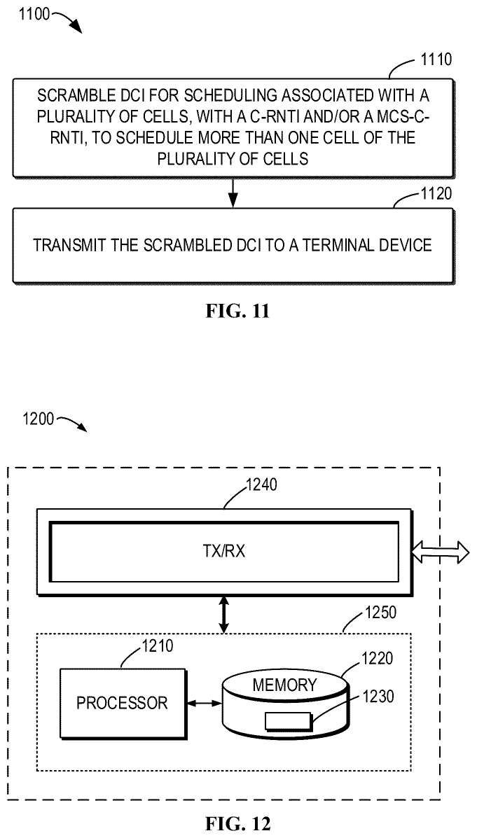

Related implementations of the present disclosure will be described in detail below with reference to FIG. 11. FIG. 11 illustrates a flowchart of a still further communication method 1100 implemented at a network device in accordance with some embodiments of the present disclosure. For the purpose of discussion, the method 1100 will be discussed with reference to FIG. 1, for example, by using the terminal device 110 and the network device 120. The method 1100 will be described from the perspective of the network device 120 in FIG. 1.

At block 1110, the network device 120 scrambles downlink control information (DCI) for scheduling associated with a plurality of cells, with a cell radio network temporary identifier (C-RNTI) and/or a modulation and coding scheme cell radio network temporary identifier (MCS-C-RNTI), to schedule more than one cell of the plurality of cells. At block 1120, the network device 120 transmits the scrambled DCI to the terminal device 110.

Additionally, in some embodiments, the network device 120 may further scramble the DCI with a configured scheduling radio network temporary identifier (CS-RNTI) to schedule one of the plurality of cells.

In some implementations, MC-DCI format 1_X/0)_X may be scrambled with a CS-RNTI activating or release SPS assignment or configured UL grant for multiple cells. The network device 120 may transmit the MC-DCI to the terminal device 110. The terminal device 110 may validate, for scheduling activation or scheduling release, a DL SPS assignment PDCCH or a configured UL grant Type 2 PDCCH for cells NDI fields indicating ‘0’. Fields for activating or release validation for single cell may be valid for those cells. The terminal device 110 may apply retransmission for cells NDI fields indicating ‘1’.

With the above embodiments and/or implementations, related benefits may be obtained. For example, maximum flexibility can be achieved for MC-DCI to support active, release and retransmit SPS/CG on different cells in a single DCI. At the same time, it may increase processing complexity while could reduce DCI overhead.

### Example Device

FIG. 12 is a simplified block diagram of a device 1200 that is suitable for implementing embodiments of the present disclosure. The device 1200 can be considered as a further example implementation of any of the first, second, third, and fourth communication devices as shown in FIG. 1. Accordingly, the device 1200 can be implemented at or as at least a part of the terminal device 110 or the network device 120.

As shown, the device 1200 includes a processor 1210, a memory 1220 coupled to the processor 1210, a suitable transmitter (TX)/receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1230 is assumed to include program instructions that, when executed by the associated processor 1210, enable the device 1200 to operate in accordance with the embodiments of the present disclosure, as discussed herein with reference to FIGS. 1 to 11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

In some embodiments, a terminal device comprises a circuitry configured to: receive, from a network device, a first configuration for a first time domain resource allocation (TDRA) list of a plurality of first TDRA lists, a first TDRA list of the plurality of first TDRA lists associated with a cell of a plurality of cells and indicating resource allocations for the cell: receive, from the network device, a second configuration for a second TDRA list, the second TDRA list indicating resource allocations for the plurality of cells; and receive, from the network device, an indication of a set of entries in the second TDRA list, the set of entries indicating resource allocations for a plurality of scheduled cells of the cells.

In some embodiments, a network device comprises a circuitry configured to: transmit, to a terminal device, a first configuration for a plurality of first TDRA lists, a first TDRA list of the plurality of first TDRA lists associated with a cell of a plurality of cells and indicating resource allocations for the cell: transmit, to the terminal device, a second configuration for a second TDRA list, the second TDRA list indicating resource allocations for the plurality of cells; and transmit, to the terminal device, an indication of a set of entries in the second TDRA list, the set of entries indicating resource allocations for a plurality of scheduled cells of the cells.

In some embodiments, a terminal device comprises a circuitry configured to: receive, from a network device, downlink control information (DCI) for scheduling associated with a plurality of cells; and validate the scheduling based on at least one or more new data indicators (NDIs) associated with the plurality of cells in the DCI.

In some embodiments, a network device comprises a circuitry configured to: transmit, to a terminal device, downlink control information (DCI) for scheduling associated with a plurality of cells, wherein one or more new data indicators (NDIs) associated with the plurality of cells in the DCI is set to predetermined values to enable the terminal device to validate the scheduling.

In some embodiments, a network device comprises a circuitry configured to: scramble downlink control information (DCI) for scheduling associated with a plurality of cells, with a cell radio network temporary identifier (C-RNTI) and/or a modulation and coding scheme cell radio network temporary identifier (MCS-C-RNTI), to schedule more than one cell of the plurality of cells; and transmit the scrambled DCI to a terminal device.

The circuitry may be configured to perform all the operations of the terminal device and/or the network device as described above with reference to FIGS. 2-11.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a communication method comprises: at a terminal device, receiving, from a network device, a first configuration for a first time domain resource allocation (TDRA) list of a plurality of first TDRA lists, a first TDRA list of the plurality of first TDRA lists associated with a cell of a plurality of cells and indicating resource allocations for the cell: receiving, from the network device, a second configuration for a second TDRA list, the second TDRA list indicating resource allocations for the plurality of cells; and receiving, from the network device, an indication of a set of entries in the second TDRA list, the set of entries indicating resource allocations for a plurality of scheduled cells of the cells.

In some embodiments, the first and/or second configuration is received in radio resource control (RRC) signaling, and/or the indication of the set of entries is received in downlink control information (DCI).

In some embodiments, an entry in the set of entries comprises an entry index indicating an entry in a first TDRA list of the first TDRA lists associated with a scheduled cell of the plurality of scheduled cells, and the entry in the first TDRA list comprises resource allocation information for the scheduled cell.

In some embodiments, the entry in the set of entries further comprises: an index of the scheduled cell, and/or an index of a scheduled bandwidth part of the scheduled cell.

In some embodiments, an entry in the set of entries comprises an index of resource allocation information for a scheduled cell of the plurality of scheduled cells.

In some embodiments, the indication of the set of entries indicates an index of the resource allocation information for the plurality of scheduled cells.

In some embodiments, an entry in the set of entries indicates that a cell of the plurality of cells is non-scheduled.

In some embodiments, entries in the second resource allocation are divided into a plurality of groups of entries, and a group of the plurality of groups is associated with a cell of the plurality of cells.

In some embodiments, two entries in the group comprise the same entry index.

In some embodiments, the numbers of entries in two of the plurality of groups are the same.

In one solution, a communication method comprises: at a network device, transmitting, to a terminal device, a first configuration for a plurality of first TDRA lists, a first TDRA list of the plurality of first TDRA lists associated with a cell of a plurality of cells and indicating resource allocations for the cell: transmitting, to the terminal device, a second configuration for a second TDRA list, the second TDRA list indicating resource allocations for the plurality of cells; and transmitting, to the terminal device, an indication of a set of entries in the second TDRA list, the set of entries indicating resource allocations for a plurality of scheduled cells of the cells.

In some embodiments, the first and/or second configuration is transmitted in radio resource control (RRC) signaling, and/or the indication of the set of entries is transmitted in downlink control information (DCI).

In some embodiments, an entry in the set of entries comprises an entry index indicating an entry in a first TDRA list of the first TDRA lists associated with a scheduled cell of the plurality of scheduled cells, and the entry in the first TDRA list comprises resource allocation information for the scheduled cell.

In some embodiments, the entry in the set of entries further comprises: an index of the scheduled cell, and/or an index of a scheduled bandwidth part of the scheduled cell.

In some embodiments, an entry in the set of entries comprises an index of resource allocation information for a scheduled cell of the plurality of scheduled cells.

In some embodiments, the indication of the set of entries indicates an index of the resource allocation information for the plurality of scheduled cells.

In some embodiments, an entry in the set of entries indicates that a cell of the plurality of cells is non-scheduled.

In some embodiments, entries in the second resource allocation are divided into a plurality of groups of entries, and a group of the plurality of groups is associated with a cell of the plurality of cells.

In some embodiments, two entries in the group comprise the same entry index.

In some embodiments, the numbers of entries in two of the plurality of groups are the same.

In one solution, a communication method comprises: at a terminal device, receiving, from a network device, downlink control information (DCI) for scheduling associated with a plurality of cells; and validating the scheduling based on at least one or more new data indicators (NDIs) associated with the plurality of cells in the DCI.

In some embodiments, the DCI includes a plurality of NDIs, and an NDI of the plurality of NDIs is associated with a cell of the plurality of cells.

In some embodiments, the one or more NDIs comprise the plurality of NDIs, and validating the scheduling based on at least the one or more NDIs comprises: in accordance with a determination that the plurality of NDIs is all zero, determining that the scheduling is valid.

In some embodiments, the one or more NDIs comprise one or more NDIs of the plurality of NDIs set to zeros and associated with one or more cells of the plurality of cells, and validating the scheduling based on at least the one or more NDIs comprises: determining, based on the one or more NDIs set to zeros, that scheduling of the one or more cells is to be validated; and validating the scheduling of the one or more cells.

In some embodiments, validating the scheduling further comprises: determining, based on a field of an NDI of the plurality of NDIs set to all ones and associated with a cell of the plurality of cells, that scheduling of the cell is not to be validated.

In some embodiments, validating the scheduling based on at least the one or more NDIs comprises: in accordance with a determination that the DCI is scrambled with a configured scheduling radio network temporary identifier (CS-RNTI), determining that the scheduling is to be validated; and in accordance with a determination that the scheduling is to be validated, validating the scheduling based on at least the one or more NDIs.

In some embodiments, the scheduling comprises activation or deactivation of a configured grant or semi-persistent scheduling (SPS) assignment associated with the plurality of cells.

In some embodiments, validating the scheduling based on at least the one or more NDIs comprises: validating the scheduling based on one or more further fields in the DCI, the one or more further fields related to: one or more hybrid automatic repeat request (HARQ) process numbers, redundancy versions, modulation and coding schemes, and/or frequency domain resource assignment, associated with the plurality of cells.

In one solution, a communication method comprises: at a network device, transmitting, to a terminal device, downlink control information (DCI) for scheduling associated with a plurality of cells, wherein one or more new data indicators (NDIs) associated with the plurality of cells in the DCI is set to predetermined values to enable the terminal device to validate the scheduling.

In some embodiments, the DCI includes a plurality of NDIs, and an NDI of the plurality of NDIs is associated with a cell of the plurality of cells.

In some embodiments, the one or more NDIs comprise the plurality of NDIs, and the predetermined values are zeros.

In some embodiments, the one or more NDIs are associated with one or more cells of the plurality of cells to indicate that scheduling of the one or more cells is to be validated.

In some embodiments, a field of an NDI of the plurality of NDIs is set to all ones to indicate that scheduling of a cell of the plurality of cells associated with the NDI comprises retransmission of a configured grant (CG) or semi-persistent scheduling (SPS) assignment for the cell.

In some embodiments, transmitting the DCI comprises: scrambling the DCI with a configured scheduling radio network temporary identifier (CS-RNTI) to indicate that the scheduling is to be validated; and transmitting the scrambled DCI to the terminal device.

In some embodiments, the scheduling comprises activation or deactivation of a configured grant or semi-persistent scheduling (SPS) assignment associated with the plurality of cells.

In some embodiments, one or more further fields in the DCI are set to predetermined values to enable the terminal device to further validate the scheduling, the one or more further fields related to: one or more hybrid automatic repeat request (HARQ) process numbers, redundancy versions (RVs), modulation and coding schemes (MCSs), and/or frequency domain resource assignment (FDRA), associated with the plurality of cells.

In one solution, a communication method comprises: at a network device, scrambling downlink control information (DCI) for scheduling associated with a plurality of cells, with a cell radio network temporary identifier (C-RNTI) and/or a modulation and coding scheme cell radio network temporary identifier (MCS-C-RNTI), to schedule more than one cell of the plurality of cells; and transmitting the scrambled DCI to a terminal device.

In some embodiments, the method further comprises: scrambling the DCI with a configured scheduling radio network temporary identifier (CS-RNTI) to schedule one of the plurality of cells.

In further solution, a device comprises: at least one processor; and at least one memory storing instructions that, when executed by the at least one processor, cause the device to perform the method implemented by the terminal device above.

In further solution, a device comprises: at least one processor; and at least one memory storing instructions that, when executed by the at least one processor, cause the device to perform the method implemented by the network device above.

In a further solution, a computer readable medium having instructions stored thereon, the instructions, when executed on at least one processor, causing the at least one processor to perform the method implemented by the terminal device above.

In a further solution, a computer readable medium having instructions stored thereon, the instructions, when executed on at least one processor, causing the at least one processor to perform the method implemented by the network device above.

In a yet further solution, a computer program comprising instructions, the instructions, when executed on at least one processor, causing the at least one processor to perform the method implemented by the terminal device above.

In a yet further solution, a computer program comprising instructions, the instructions, when executed on at least one processor, causing the at least one processor to perform the method implemented by the network device above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 11. Generally; program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method performed by a terminal device comprising:
receiving, from a network device, a first configuration for a first TDRA list for multiple channels in a plurality of cells; and
receiving, from the network device, downlink control information (DCI) being used for a scheduling of the multiple channels in the plurality of the cells, the DCI comprising information indicating an entry in the first TDRA list.

2. The method of claim 1, wherein
the first configuration is received in radio resource control (RRC) signaling.

3. The method of claim 1, wherein
the entry in a set of entries comprises an entry index indicating an entry in the first TDRA list of first TDRA lists associated with a scheduled cell of the plurality of scheduled cells; and
the entry in the first TDRA list comprises resource allocation information for the scheduled cell.

4. The method of claim 3, wherein the entry in the set of entries further comprises:
an index of the scheduled cell, and/or
an index of a scheduled bandwidth part of the scheduled cell.

5. The method of claim 1, wherein the entry in a set of entries comprises an index of resource allocation information for a scheduled cell of the plurality of scheduled cells.

6. The method of claim 5, wherein an indication of the set of entries indicates an index of the resource allocation information for the plurality of scheduled cells.

7. The method of claim 1, wherein the entry in a set of entries indicates that a cell of the plurality of cells is non-scheduled.

8. The method of claim 1, wherein
entries in a first resource allocation indicated by the first TDRA list, are divided into a plurality of groups of entries; and
a group of the plurality of groups is associated with a cell of the plurality of cells.

9. The method of claim 8, wherein two entries in the group comprise the same entry index.

10. The method of claim 8, wherein numbers of entries in two of the plurality of groups are the same.

11. A method performed by a network device, the method comprising:
transmitting, to a terminal device, a first configuration for a first TDRA list for multiple channels in a plurality of cells; and
transmitting, to the terminal device, downlink control information (DCI) comprising information indicating an entry in the first TDRA list.

12. The method of claim 1, wherein
the DCI comprises a plurality of New Date Indicators (NDIs) for the plurality of cells, the NDIs corresponding to the scheduling of the multiple channels.

13. The method of claim 12, wherein the DCI includes the plurality of NDIs; and an NDI of the plurality of NDIs is associated with a cell of the plurality of cells.

14. The method of claim 13, wherein one or more NDIs comprise the plurality of NDIs; and validating the scheduling based on at least the one or more NDIs comprises:
in accordance with a determination that the plurality of NDIs is all zero, determining that the scheduling is valid.

15. The method of claim 13, wherein
one or more NDIs comprise one or more NDIs of the plurality of NDIs set to zeros and associated with one or more cells of the plurality of cells; and
validating the scheduling based on at least the one or more NDIs comprises:
determining, based on the one or more NDIs set to zeros, that scheduling of the one or more cells is to be validated; and
validating the scheduling of the one or more cells.

16. The method of claim 13, wherein validating the scheduling further comprises:
determining, based on a field of an NDI of the plurality of NDIs set to all ones and associated with a cell of the plurality of cells, that a scheduling of the cell is not to be validated.

17. The method of claim 12, wherein validating the scheduling based on at least the one or more NDIs comprises:
in accordance with a determination that the DCI is scrambled with a configured scheduling radio network temporary identifier (CS-RNTI), determining that the scheduling is to be validated; and
in accordance with a determination that the scheduling is to be validated, validating the scheduling based on at least the one or more NDIs.

18. The method of claim 12, wherein the scheduling comprises activation or deactivation of a configured grant or semi-persistent scheduling (SPS) assignment associated with the plurality of cells.

19. The method of claim 12, wherein validating the scheduling based on at least the one or more NDIs comprises:
validating the scheduling based on one or more further fields in the DCI, the one or more further fields related to: one or more hybrid automatic repeat request (HARQ) process numbers, redundancy versions, modulation and coding schemes, and/or frequency domain resource assignment, associated with the plurality of cells.

20-25. (canceled)

26. The method of claim 1, wherein the method comprises:
receiving, from the network device, a second configuration for a second time domain resource allocation (TDRA) list for a single channel in a one cell.

27. The method of claim 1, wherein
the multiple channels comprise multiple PUSCHs.

28. The method of claim 1, wherein
the multiple channels comprise multiple PDSCHs.

29. The method of claim 1, wherein
the DCI is accompanied with a Cyclic Redundancy Check (CRC) scrambled by a Cell Radio Network Temporary Identifier (C-RNTI) or a Modulation and Coding Scheme Cell Radio Network Temporary Identifier (MCS-C-RNTI).

30. The method of claim 11, wherein the method comprises:
transmitting, to the terminal device, a second configuration for a second time domain resource allocation (TDRA) list for a single channel in a one cell.

31. The method of claim 11, wherein
the multiple channels comprise multiple PUSCHs.

32. The method of claim 11, wherein
the multiple channels comprise multiple PDSCHs.

33. The method of claim 12, comprising:
validating the scheduling based on at least one or more new data indicators (NDIs) associated with the plurality of cells in the DCI.

34. A terminal device comprising:
one or more memories storing instructions; and
one or more processors configured to process the instructions to control the terminal device to:
receive, from a network device, a first configuration for a first TDRA list for multiple channels in a plurality of cells; and
receive, from the network device, downlink control information (DCI) being used for a scheduling of the multiple channels in the plurality of the cells, the DCI comprising information indicating an entry in the first TDRA list.

35. The method of claim 26, wherein
the second configuration is received in radio resource control (RRC) signaling.

36. The method of claim 26, wherein
the single channel comprises Physical Uplink Shared Channel (PUSCH).
